(19) United States
(12) Patent Application Publication
(10) Pub. No.: US 2001/0039198 A1
(43) Pub. Date: Nov. 8, 2001

(54) Mobile radio communications apparatus and base station thereof, and method of antenna selection

(76) Inventors: Teruo Onishi, Yokohama-shi (JP); Kenzo Urabe, Yokohama-shi (JP)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/813,021

(22) Filed: Mar. 21, 2001

(30) Foreign Application Priority Data
Mar. 22, 2000 (JP) 2000-080466

(51) Int. Cl. H04M 1/00

(52) U.S. Cl. 455/562; 455/561; 455/67.1; 455/277.1

(57) ABSTRACT

Mobile radio communications apparatus having a plurality of transmitting antennas for performing transmission upon selecting whichever of these plurality of antennas is appropriate, wherein the appropriate antenna can be selected even in a case where an object that influences antenna characteristics is in close proximity to the antenna is disclosed. The level of reflected-waves from whichever of the antennas 3, 4 has been selected by a switch 44 is measured by a reflected-wave measurement circuit 48. If the amount of level variation exceeds a predetermined value, the other antenna is used by changing over the switch 44.

### FIELD OF THE INVENTION

The present invention relates to a mobile radio communications apparatus capable of communicating using a radio channel, and to abase station associated therewith. More particularly, the invention relates to a mobile radio communications apparatus having a plurality of transmitting antennas, and to a base station associated therewith.

The present invention relates further to a mobile radio communications apparatus having a plurality of transmitting antenna, and to a method of selecting these antennas.

### BACKGROUND OF THE INVENTION

When a mobile station moves in mobile communications, generally the distance to a base station and the direction from which radio waves coming change. Multi-path phasing occurs as well. The result is a fluctuation in the strength of radio-wave reception at the mobile station. Because a decline in the strength of radio-wave reception leads to a deterioration in communication quality, various techniques represented by the diversity technique have been proposed for the purpose of accomplishing reception at a radio-wave strength that is stable regardless of a change in the reception environment.

The diversity technique is a technique through which radio waves having little mutual correlation are received at the same time, thereby diminishing the probability that the strengths of all received radio waves will decline simultaneously. This suppresses a fluctuation in the strength of reception. Various diversity techniques are available depending upon the method of receiving radio waves having little mutual correlation and the method of utilizing the received signals.

Methods of reception include space diversity, in which a plurality of antennas are located by being spaced apart over distances that provide non-correlation; directivity diversity, in which antennas are located such that the angular ranges over which they receive will differ from one another; and polarization diversity, in which radio waves are received upon being separated into horizontally polarized and vertically polarized waves.

Methods of utilizing a plurality of received radio waves include a selective synthesis method of making selective use of radio waves having the highest strength; an equalized gain synthesis method of adding received radio waves upon matching the phases thereof; and a maximum-ratio synthesis method of adding received radio waves upon applying weighting on a per-antenna basis.

FIG. 19 is a diagram showing an example of a diversity arrangement using directivity diversity reception and the selective synthesis method. Two antennas 101 and 102 having predetermined directivities are so arranged that their areas of reception do not overlap, and the set-up is such that these antennas receive radio waves 104 and 105, respectively, which have different angles of arrival. The reception strengths of the antennas 101, 102 are measured by reception-level measurement circuits 104 and 105, respectively, and the results of these measurements are input to a comparator 106. The latter changes over a switch 103 so as to select the antenna having the higher reception strength, thereby making it possible to suppress a decline in the strength of reception.

Reception diversity is employed also in mobile telephone terminals such as PDC and GSM, and PHS terminals, etc., in order to prevent a decline in reception strength. This is achieved by incorporating a receive-only antenna within the casing besides using a whip antenna (retractable antenna).

It is possible to select the appropriate antenna at the time of reception as by utilizing reception signal strength in the manner described above. With regard to transmission, there are many cases in which reception diversity is carried out on the base-station side and, hence, one antenna is used.

Generally speaking, the characteristics of antennas are varied by effects of a nearby object. Therefore, such a object present near an antenna being in communication may prevent stable communication.

To solve this problem, it is considered to use an antenna having its antenna pattern oriented in the direction where its characteristics are less affected by such a object (for example, in the backward direction of an mobile telephone terminal). However, in the use of an antenna having its antenna pattern oriented in a special direction, users are not aware of the direction of the antenna pattern, so that the antenna pattern may be oriented in the direction of the object in some cases. Therefore, the method descried above has the possibility of providing adverse effect. A mobile communications terminal such as a mobile telephone (e.g. PDC or GSM) or PHS telephone often is used for applications, such as data communication, other than voice communication. In view of the increasingly diverse environments in which such terminals are used, relying solely upon an antenna of which antenna pattern directed to specific direction is undesirable.

It has been contemplated to use the above-mentioned antenna in combination with an antenna having another antenna pattern, e.g., an antenna pattern that emits radio waves only in the direction in which the microphone and speaker are provided, and selectively use one of these antennas for transmission based upon the results of reception diversity. In other words, this is an approach that assumes that if an antenna exhibiting good reception is used for transmission, then transmission also will be good. In the reception diversity technique, however, unerring selection is difficult in cases where there is not that much discrepancy in reception signal strength. If the wrong antenna is selected for use, a decline in quality is unavoidable in both reception and transmission.

### SUMMARY OF THE INVENTION

The present invention has been devised in view of the foregoing problems of the prior art and an object thereof is to provide a mobile radio communications apparatus having a plurality of transmitting antennas for performing transmission upon selecting whichever of these plurality of antennas is appropriate, as well as a method of selecting antennas, wherein the appropriate antenna can be selected even in a case where an object that influences antenna characteristics is in close proximity to the antenna.

Another object of the present invention is to provide a base station that contributes to selection of an appropriate antenna in a mobile radio communications apparatus having a plurality of transmitting antennas for performing transmission upon selecting whichever of these plurality of antennas is appropriate.

One aspect of the present invention resides in a mobile radio communications apparatus having a plurality of transmitting antennas and being capable of communicating via a radio channel, characterized in that antenna selection circuit for dynamically selecting, based on a predetermined condition, an antenna form a plurality of transmitting antennas and transmitting circuit for providing a transmit signal to the selected antenna.

Another aspect of the present invention resides in a mobile radio communications apparatus having at least one receiving antenna and a plurality of transmitting antennas and being capable of communicating via a radio channel, characterized by comprising: a transmit circuit for generating a transmit signal supplied to the transmitting antennas; a receive circuit for processing a receive signal received from the receiving antenna; switch means for connecting one of the plurality of transmitting antennas to the transmit circuit in accordance with a control signal; and control means for generating the control signal based upon predetermined conditions.

Another aspect of the present invention resides in a base station for radio communication with a mobile radio communications apparatus having a plurality of transmitting antennas, characterized by comprising: reception-quality measurement means for measuring reception quality in regard to each type of the transmitting antennas used in transmission involving the mobile radio communications apparatus; and transmit means for sending results of measurement back to the mobile radio communications apparatus.

Another aspect of the present invention resides in a method of selecting a transmitting antenna in a mobile radio communications apparatus capable of communicating via a radio channel having at least one receiving antenna, a plurality of transmitting antennas, a receive circuit for processing a receive signal received from the receiving antenna, and switch means for connecting one of the plurality of transmitting antennas to the transmit circuit in accordance with a control signal, characterized by having a control step of generating the control signal based upon predetermined conditions.

### BRIEF DESCRIPTION OF THE DRAWINGS

FIGS. 1A and 1B are diagrams showing the general configuration of a mobile radio communications apparatus according to an embodiment of the present invention;

FIGS. 2A and 2B are diagrams showing the transmission patterns of antennas possessed by the mobile radio communications apparatus according to the embodiment of the present invention;

FIG. 3 is a diagram showing an example in which the mobile radio communications apparatus according to the embodiment of the present invention is in use;

FIG. 4 is a diagram showing an example of a case where the mobile radio communications apparatus according to the embodiment of the present invention is used in data communication;

FIG. 5 is a block diagram showing an example of the circuit structure of a principle portion of the mobile radio communications apparatus according to the embodiment of the present invention;

FIG. 6 is a flowchart useful in describing processing for selecting a transmitting antenna in a first embodiment of the present invention;

FIG. 7 is a diagram showing a data format sent and received between a mobile radio communications apparatus and a base station in a second embodiment of the present invention;

FIG. 8 is a flowchart useful in describing processing for selecting a transmitting antenna in a second embodiment of the present invention;

FIG. 9 is a diagram showing an example of antennas selected in the second embodiment of the present invention;

FIG. 10 is a block diagram showing an example of the circuit structure of a principle portion of the mobile radio communications apparatus according to a third embodiment of the present invention;

FIG. 11 is a flowchart useful in describing processing for selecting a transmitting antenna in a third embodiment of the present invention;

FIG. 12 is a block diagram showing an example of the circuit structure of a principle portion of the mobile radio communications apparatus according to a fourth embodiment of the present invention;

FIG. 13 is a block diagram showing an example of the circuit structure of a switch 44 according to a fourth embodiment of the invention.

FIG. 14 is a flowchart useful in describing processing for selecting a transmitting antenna in a fourth embodiment of the present invention;

FIG. 15 is an example of the calculated values of the amounts of level variation and the amounts of phase variation;

FIG. 16 is a flow chart in which the correction processing in accordance with the embodiment is applied to the Step S200 shown in FIG. 14;

FIG. 17 shows ideal values, calculated values including leakage signals and calculated values corrected by the method in accordance with this embodiment with regard to the signal level and phase difference of a reflected-wave;

FIG. 18 is a diagram showing an example of antennas selected in another embodiment of the present invention; and

FIG. 19 is a diagram useful in describing a reception diversity technique.

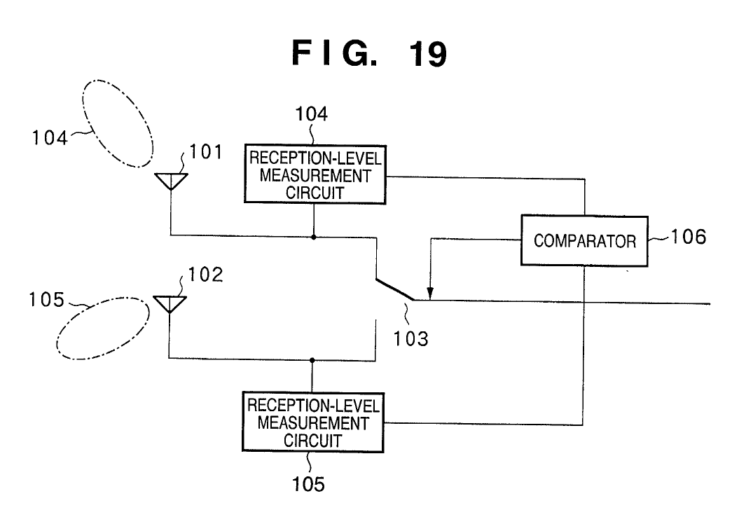

### DETAILED DESCRIPTION OF THE PREFERRED EMBODIMENTS

[First Embodiment]

The present invention will be described on the basis of an embodiment thereof with reference to the drawings.

[Antenna Arrangement and Characteristics]

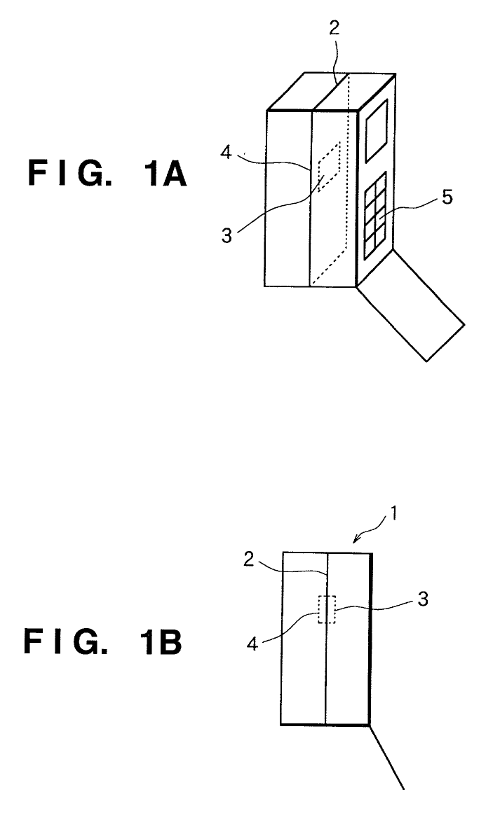

FIGS. 1A and 1B are diagrams illustrating an example of the structure of mobile telephone terminal serving as a mobile radio communications apparatus according to the present invention, in which FIG. 1A is a partially see-through perspective view and FIG. 1B a vertical sectional view.

A mobile telephone terminal 1 has a ground conductor 2 provided inside a case and includes two antennas 3 and 4 disposed on either side of the ground conductor 2. A control panel 5 serves as an interface between the mobile telephone terminal 1 and the user and is provided with numeric keys and function keys, etc.

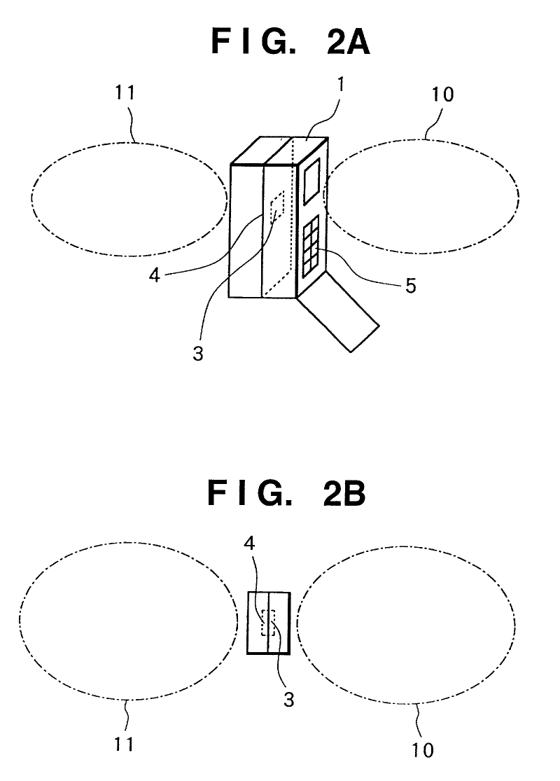

The antennas 3 and 4 have mutually different transmit/receive directions. For example, as shown in FIGS. 2A and 2B, the antenna 3 receives radio waves 10 that arrive from the direction of the control panel 5 and transmits radio waves 10 in the direction of the control panel 5. On the other hand, the antenna 4 receives radio waves 11 that arrive from the direction opposite that of the control panel 5 and transmits radio waves 11 in the direction away from the control panel 5.

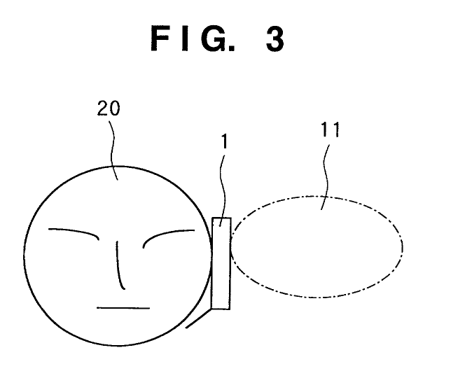

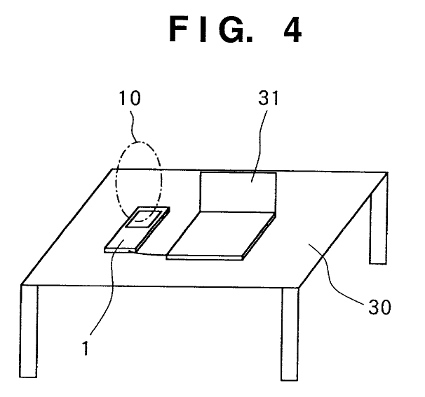

As shown in FIG. 3, when a mobile telephone terminal 1 is close to a user's face 20 or hold on the user's body by means of a wristband or holder during a voice communication, an antenna 4 is used for the communication. Alternatively, as shown in FIG. 4, when the mobile telephone terminal 1 is placed on a desk 30 or the like with its control panel 5 upward and a computer 31 is used for data communication, an antenna 3 is used for the communication. (Circuit construction of mobile radio communications apparatus)

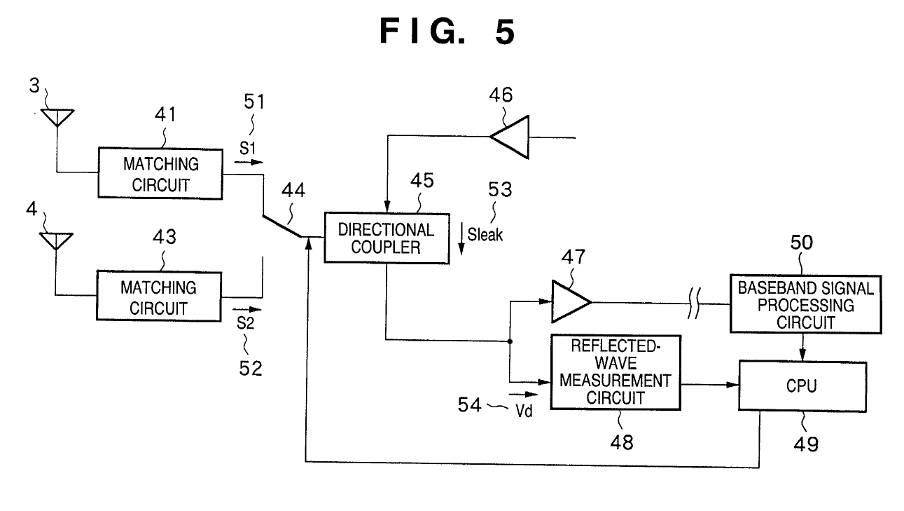

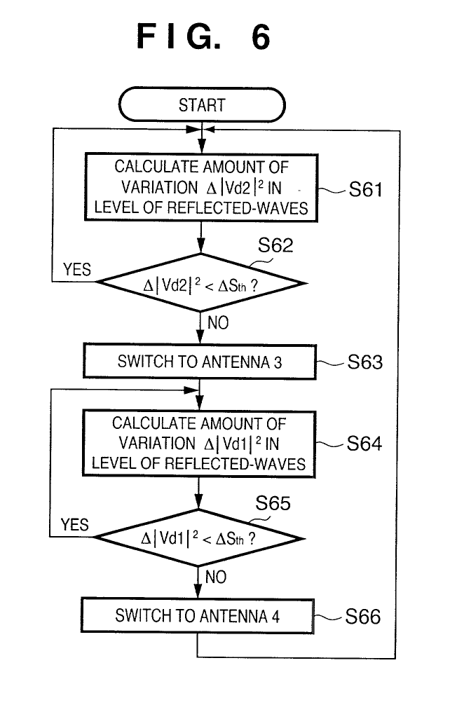

Processing for selecting an antenna in accordance with this embodiment will now be described in detail with reference to FIGS. 5 and 6.

FIG. 5 is a block diagram showing an example of the construction of that part of the mobile radio communications apparatus of this embodiment that relates to antenna selection processing.

The antennas 3 and 4 shown in FIG. 5 are identical with those depicted in FIGS. 1 and 2 and have mutually different antenna patterns. Matching circuits 41 and 43 are connected to the antennas 3 and 4, respectively. In accordance with control executed by a CPU 49, a changeover switch 44 selects either antenna 3 or 4 and connects it to a directional coupler 45. An amplifier 46 amplifies a transmit signal, which has been received from a transmit circuit (not shown), and supplies the amplified signal to the directional coupler 45. Further, an amplifier 47 amplifies an output signal from the directional coupler 45 and supplies the amplified signal to a demodulator circuit (not shown). The demodulated receive signal is supplied to a baseband signal processing circuit 50.

An output signal from a directional coupler 45 is supplied to an amplifier 47 and also to a reflected-wave measurement circuit 48. Generally, when a object approaches to an antennas, the impedance of the antenna varies, so that a part of the signal input into the antenna is returned as a reflected-wave. The reflected-wave measurement circuit 48 measures the level of such a reflected-wave signal generated by the antennas 3 and 4. A result of measurement of the level of the reflected-wave signal is output to a CPU 49, which controls the whole mobile radio communication device. The CPU 49 controls a selection switch 44 in response to the level of the reflected-wave signal from each antenna.

Matching circuits 41 and 43 have antenna 3 and 4 impedance-matching to internal circuits of a mobile radio communication apparatus 1. Signals S1 and S2 represent reflected-waves generated at antenna 3 and 4, respectively. A signal Vd (54) represents a reflected-wave actually input into the reflected-wave measurement circuit 48 through the selection switch 44 and the directional coupler 45.

Further, Sₗₑₐₖ (53) represents a leakage signal of a transmitting signal from the directional coupler 45. In the first embodiment, it is assumed that the level of such a leakage signal can be negligible.

Here, it is assumed that reflected-waves S1 and S2 have amplitude values |Vd1| and |Vd2|, respectively, when they are actually input into the reflected-wave measurement circuit 48. Then, the amounts of signal level variation of each of the reflected-waves Δ|Vd1|² and Δ|Vd2|² can be expressed as follows, respectively:

Δ|Vd1|²=| |Vd1|²−|Vd10|² | (1)

Δ|Vd2|²=| |Vd2|²−|Vd20|² | (2)

Therein, |Vd10| and |Vd20| represent the amplitudes of reflected-waves when antenna 3 and 4 are impedance-matched by matching circuits 41 and 43 within the predetermined matching-range in a situation with no nearby object, respectively (these amplitudes is the amplitude values actually input into the reflected-wave measurement circuit 48). The square of each term implies that signal levels are considered as electric power.

(Antenna selection processing)

Antenna selection processing according to this embodiment will be described further with reference to the flowchart shown in FIG. 6. The mobile telephone terminal of this embodiment will be described assuming that the antenna 4 is used first. However, it is of course possible to adopt an arrangement in which antenna 3 is the antenna used first.

First, with regard to antenna 4, the amount of variation Δ|Vd2|² in the reflected-waves is measured continuously by the reflected-wave measurement circuit 48 (step S61). The CPU 49 compares a predetermined threshold value ΔSth of amount of variation with Δ|Vd2|² measured at step S61 (step S62). If Δ|Vd2|² is smaller than ΔSth, the antennas are not switched, control returns to step S61 and measurement of Δ|Vd2|² is repeated. If Δ|Vd2|² is equal to or greater than ΔSth, on the other hand, the CPU 49 controls the changeover switch 44 to change over antennas in such a manner that transmission is performed using antenna 3 (step S63).

After the changeover is made, the amount of variation Δ|Vd1|² in the level of reflected-waves is measured continuously with regard to the antenna 3 (step S64) and the CPU 49 compares the predetermined threshold value ΔSth of amount of variation with Δ|Vd1|² measured at step S64 (step S65). If Δ|Vd1|² is smaller than ΔSth, the antennas are not switched, control returns to step S64 and measurement of Δ|Vd1|² is repeated. If Δ|Vd1|² is equal to or greater than ΔSth, on the other hand, the CPU 49 controls the changeover switch 44 to change over antennas in such a manner that transmission is performed using antenna 4 (step S66).

Thus it is possible to achieve excellent transmission at all times by continuously executing the processing described above.

(Modification of First Embodiment)

According to the first embodiment, the amount of variation in the level of reflected-waves is measured only with regard to the antenna currently in use and this value is compared with a threshold value. However, it is possible to adopt an arrangement in which the amount of variation in the level of reflected-waves is measured with regard to both antennas and whichever antenna provides the smaller value of Δ|Vd1|² and Δ|Vd2|² is used. In such case, as described in the second embodiment, it is possible to measure the variation amount of the reflected-wave level by utilizing time-divided pilot-symbol segment or, it would suffice to use two reflected-wave measurement circuits, place them between the respective matching circuits and the changeover switch 44 and input the results of measurement to the CPU 49.

[Second Embodiment]

According to the first embodiment, the switching of the antenna used is decided depending solely upon the result of measurement performed on the side of the mobile telephone terminal. This embodiment, however, it characterized in that antenna changeover is decided using also the results of reception at the base station.

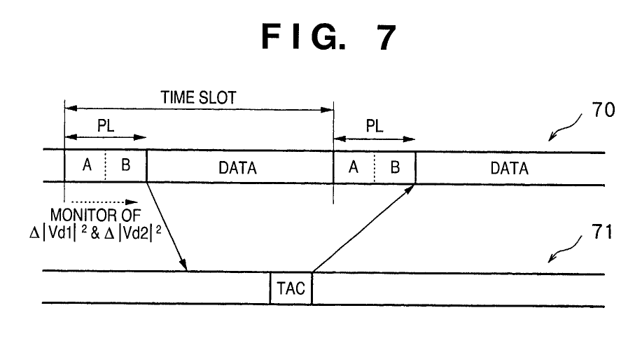

FIG. 7 is a diagram illustrating an exchange of data relating to antenna selection performed between a mobile telephone terminal (MS) and base station (BTS) in this embodiment.

Numeral 70 in FIG. 7 denotes the format of data (uplink data) transmitted from the mobile telephone terminal to the base station. Similarly, numeral 71 denotes the format of data (downlink data) transmitted from the base station to the mobile telephone terminal. The uplink data is composed of a plurality of time slots, and each time slot has a pilot-symbol (PL) segment and a data segment. The PL segment sends a control signal (pilot symbol) such as pattern data for synchronizing time slots.

In this embodiment, the PL segment is divided into two halves, one of which is transmitted using antenna 3 and the other of which is transmitted using antenna 4. For example, the first-half portion of the pilot segment in FIG. 7 indicated by “A” is transmitted using antenna 3, and the second-half portion “B” is transmitted by antenna 4. At the same time, the amount of variation of the reflected-wave level Δ|Vd1|² and Δ|Vd2|² are calculated, as in the first embodiment, and the antenna to be used in transmission in the ensuing data segment is decided based upon the relative magnitudes of the calculated values.

Meanwhile, the base station has at least transceivers for communicating with mobile telephone terminals and a signal-to-interference ratio (SIR) measurement circuit for measuring reception-quality of signals transmitted from mobile telephone terminals. By the signal-to-interference ratio measurement circuit, the signal-to-interference ratio is measured in regard to the receive signal of the pilot segment and the results of measurement regarding the segments A and B are transmitted to the mobile telephone terminal as transmitting-antenna control data (TAC). When the result of SIR measurement is received by the mobile telephone terminal, the latter takes the result of SIR measurement into consideration as well as the amount of variation of the reflected-wave level Δ|Vd1|² and Δ|Vd2|² and decides the antenna to be used in the ensuing data segment.

The antenna control data may be inserted into an area containing other control data or a dedicated area for TAC in the data that is transmitted from the base station to the mobile telephone terminal.

(Antenna selection processing)

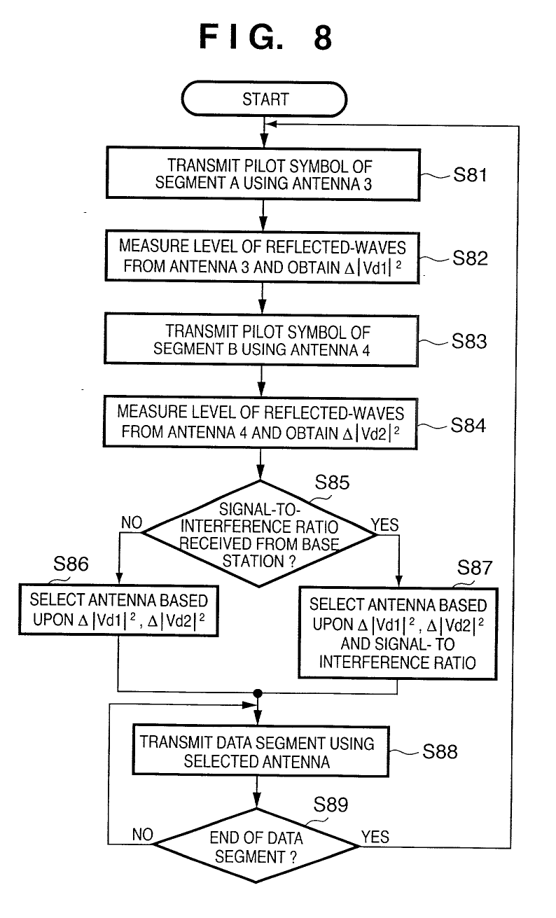

Reference will now be had to FIG. 8 to describe processing for selecting a transmitting antenna in this embodiment. It should be noted that the structure of the mobile telephone terminal may be identical with that according to the first embodiment (FIG. 5) and need not be described again.

FIG. 8 is a flowchart illustrating transmitting-antenna selection processing carried out by the mobile telephone terminal in this embodiment. First, the pilot segment A is transmitted using the antenna 3 (step S81). During this time the level of reflected-waves from the antenna 3 is measured by the reflected-wave measurement circuit 48 and, in a manner similar to that of the first embodiment, Δ|Vd1|² is calculated (step S82).

When segment A ends, the changeover switch 44 is changed over and the pilot symbol of segment B is transmitted using the antenna 4 (step S83). During this time the level of reflected-waves from the antenna 4 is measured by the reflected-wave measurement circuit 48 and, in a manner similar to that of the first embodiment, Δ|Vd2|² is calculated (step S84).

Next, it is determined whether the signal-to-interference ratio is being received from the base station (step S85). If the signal-to-interference ratio is not being received, the antenna to be used in transmitting the data segment is selected based solely upon the comparison of Δ|Vd1|² and Δ|Vd2|² (step S86). If the signal-to-interference ratio is being received, however, the antenna to be used in transmitting the data segment is selected based upon the comparison of Δ|Vd1|² and Δ|Vd2|² and the signal-to-interference ratio that has been received (step S87).

Transmission of the data segment is then carried out using the antenna selected at step S86 or S87 (steps S88-S89). When the data segment ends, control returns to step S81 and transmission of the pilot symbol of segment A using antenna 3 is performed. By repeatedly executing the processing set forth above, it is possible to transmit the data segment using the optimum antenna at all times.

The antenna selection processing executed at steps S86 and S87 will be described in greater detail.

First, in a case where an antenna is selected based upon Δ|Vd1|² and Δ|Vd2|² without using the signal-to-interference ratio (step S86), the antenna for which the amount of variation in reflected-wave level is smaller is selected. This can be stated as follows:

in case of Δ|Vd1|²<Δ|Vd2|², select antenna 3; and

in case of Δ|Vd1|²>Δ|Vd2|² select antenna 4.

If Δ|Vd1|²=Δ|Vd2|² holds, a predetermined one of the antennas is selected. In this condition, selection may be fixed to one of the antennas, use may be made of the antenna that was employed in transmission of the data segment of the preceding time slot, or no antenna changeover need be made, i.e., that antenna that was employed in transmission of segment B may be used continuously. Also, both of antenna 3 and 4 may be used. Further, a dead zone may be provided rather than relying upon a stringent size relationship. More specifically, this can be stated as follows:

in a case where Δ|Vd1|²<Δ|Vd2|² holds and the absolute value of (Δ|Vd1|²−Δ|Vd2|²) is equal to or greater than a predetermined value, select antenna 3;

in a case where Δ|Vd1|²>Δ|Vd2|² holds and the absolute value of (Δ|Vd1|²−Δ|Vd2|²) is equal to or greater than a predetermined value, select antenna 4; and

in all other cases, select the antenna that was used in transmitting segment B (or the antenna that was used in transmitting the data segment of the preceding time slot).

If the signal-to-interference ratio is being received from the base station (step S87), the antenna is selected depending upon the size relationship between Δ|Vd1|² and Δ|Vd2|² and the size relationship between the signal-to-interference ratio (SIR1) in segment A and the signal-to-interference ratio (SIR2) in segment B.

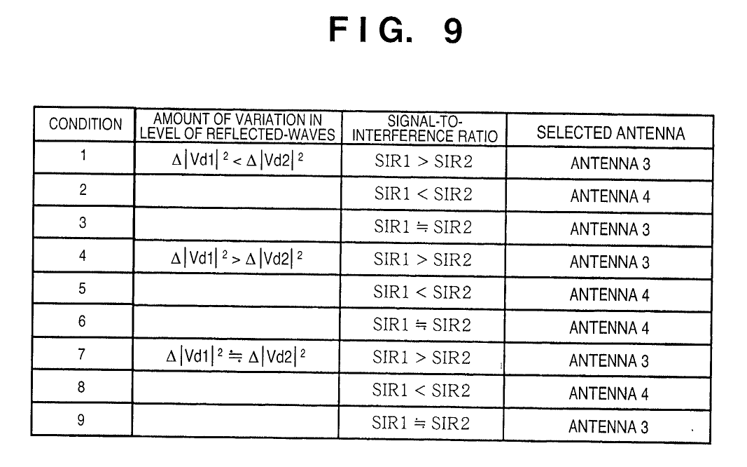

FIG. 9 is a diagram illustrating an example of the antenna selection conditions. In general, if the amount of variation in the level of reflected-waves is small and the signal-to-interference ratio measured at the base station is large, the antenna that satisfies these conditions is selected. In other words, antennas 3 and 4 are selected with regard to conditions 1 and 5, respectively.

The amount of variation in the level of reflected-waves and the signal-to-interference ratio do not always satisfy the above-described relationship because of phenomena that occur along the transmission path. For example, as indicated at conditions 2 and 4, a case is conceivable in which even though the amount of variation in the level of reflected-waves is small, the corresponding signal-to-interference ratio is small. In the example shown in FIG. 9, it is so arranged that the antenna is selected giving priority to the received signal-to-interference ratio in this case.

Further, as indicated at conditions 3 and 6, the antenna for which the amount of variation in reflected-wave level is smaller is selected in a case where the signal-to-interference ratios are approximately equal. Further, as indicated at conditions 7 and 8, the antenna for which the signal-to-interference ratio is larger is selected in a case where the amounts of variation in reflected-wave levels are approximately equal.

In a case where there is almost no difference in the amount of variation in reflected-wave level and in the signal-to-interference ratio, as indicated at condition 9, a predetermined one of the antennas, e.g., antenna 3, is selected.

Of course, it is possible to change the relationship between the conditions and the antenna selected. In particular, with regard to an antenna selected in a case where the relationship between the amount of variation in reflected-wave level and the signal-to-interference ratio is the opposite of what is usual, as at condition 2 or 4, or in a case where there is no difference in the amount of variation in reflected-wave level, as at conditions 7 and 8, it is possible to adopt a set-up such that the selections made are the opposite of those shown in FIG. 9.

[Third Embodiment]

Now, the third embodiment of the present invention will be explained. In the first embodiment, level variations of reflected-waves caused by a variation in the impedance of antennas are used for selection of antennas. This embodiment is characterized in that the selection of antennas is performed by using phase variations of reflected-waves caused by a variation in the impedance of antennas.

In the first embodiment, only the signal levels of reflected-waves, i.e. the amplitude of reflected-waves, are used for the selection of antennas. On the other hand, in this embodiment, the phases of reflected-waves are used for the selection, so that reflected-waves are processed including their imaginary parts. Here, assuming that Fi represents a reflection coefficient at the end of antennas, then Γi can be expressed as follows:

Γi=|Γi|e^{jθ} (3)

Therein, |Γi| represents the amplitude component and θ represents its phase component. By using these representations, the reflected-wave V_{Ri} can be expressed as a function of the input signal V_{Ii} and the reflection coefficient Γi as follows:

V_{Ri}=Γi·V_{Ii}=|Γi| |V_{Ii}|e^{-j(β1-θ)}

Therein, V_{Ri} and V_{Ii} represent the reflected-wave and input signal at the end of an antenna, respectively. β and 1 represent the phase constant and the position of the antenna, respectively.

(Circuit Configuration for Mobile Radio Communication Devices)

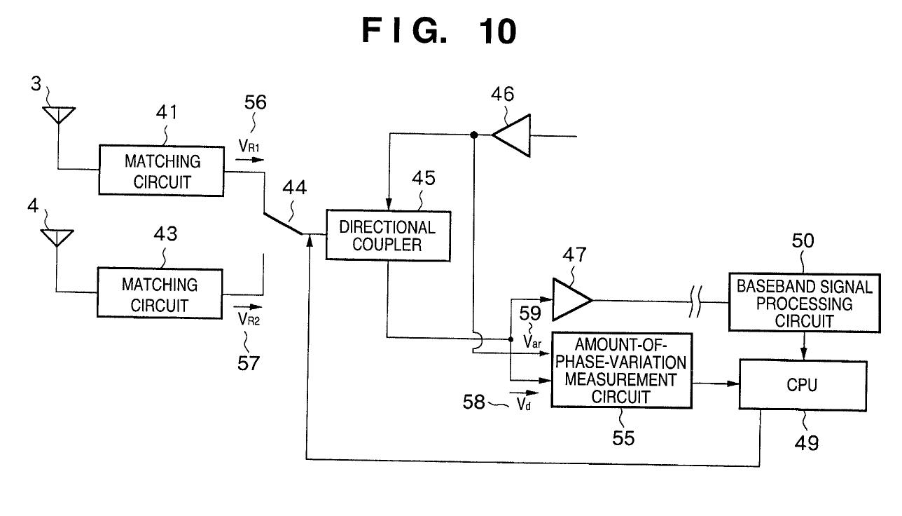

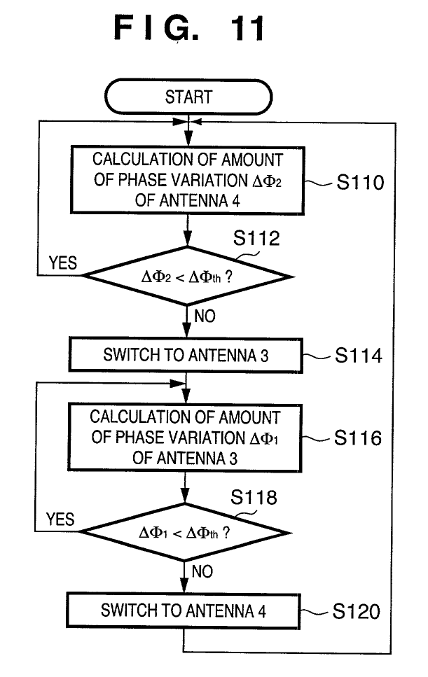

Referring now to FIGS. 10 and 11, the selection processing for antennas in this embodiment will be explained in detail.

FIG. 10 is a block diagram for illustrating an example of the circuit configuration of the part associated with the antenna selection processing in the mobile radio communication device in accordance with this embodiment. In FIG. 10, components common to the configuration shown in FIG. 5 described in the first embodiment are referred to by the same numerals used in FIG. 5 and their explanation will be omitted. As is clear from comparison of FIG. 5 and FIG. 10, the configuration of FIG. 10 is the same with that of FIG. 5, except the following two differences. One is in that an amount-of-phase-variation measurement circuit 55 is provided for measuring an amount of phase variation of a reflected-wave in stead of the reflected-wave measurement circuit 48. The other is in that the output signal from the transmitting amplifier 46 also is input to the amount-of-phase-variation measurement circuit 55.

Further, V_{R1} (56) and V_{R2} (57) represent the reflected-waves caused by the reflection at the antennas 3 and 4, respectively. Vd (58) further represents either of the reflected-wave V_{R1} (56) or V_{R2} (57) actually input into the amount-of-phase-variation measurement circuit 55 through the switch 44 and the circulator 45. Further, Var (59) represents a signal which is an output signal from the transmitting amplifier 46 and which is actually input into the amount-of-phase-variation measurement circuit 55.

Furthermore, even in this embodiment, there is a leakage signal of a transmitting signal from the directional coupler 45, but, for the sake of clarity, it is assumed in this explanation that the existence of the leakage signal is negligible.

The amount-of-phase-variation measurement circuit 55 measures the phase difference between the signal Vd (58) of the reflected-wave, provided from the antennas 3 or 4 and actually input to the measurement circuit 55, and the transmitting signal Var (59). Then the amount-of-phase-variation measurement circuit 55 determines a difference, i.e. an amount of phase variation, between the measured phase difference as described above and the phase difference measured when antenna 3 and 4 are impedance-matched by the matching circuit 41 and 43 within the predetermined matching-range in a situation with no nearby object. This result of measurement of an amount of phase variation is output to the CPU 49, which controls the whole mobile radio communication device. Then, the CPU 49 controls the selection switch 44 according to the amounts of phase variations of the reflected-waves from each antenna for selecting an appropriate antenna.

Here, a method for measuring an amount of phase variation in the amount-of-phase-variation measurement circuit 55 will be specifically explained. First, the amount-of-phase-variation measurement circuit 55 multiplies the reflected-wave Vd (=Vd1 or Vd2) input from the antenna 3 or 4 by the input transmitting signal Var, and then removes higher frequency components from the results of multiplication for providing only a direct current component V_{OUT}. This direct current component V_{OUT} obtained can be generally expressed as follows:

$${V}_{out} = \frac{{V}_{d} \times {V}_{ar}}{2} cos ( θ d - φ ) \qquad ( 4 )$$

Therein, θd represents the phase of the reflected-wave Vd and φ represents the phase of the transmitting signal Var. Therefore, the phase difference Φ(=(θd−φ)) between the reflected-wave Vd and the transmitting signal Var can be expressed from this equation as follows:

$$Φ = θ d - φ = {cos}^{- 1} [ \frac{2}{{V}_{d} \times {V}_{ar}} \times {V}_{OUT} ] \qquad ( 5 )$$

Thus, the phase difference Φ can be determined from Vd, Var, and V_{OUT}. The amount-of-phase-variation measurement circuit 55 measures in advance, for each antenna, the phase difference when antenna 3 and 4 are impedance-matched by the matching circuit 41 and 43 within the predetermined matching-range in a situation with no nearby object. Here, the phase difference obtained in this manner is designated as reference phase-difference Φ₀. Then, the measurement circuit 55 determines the absolute value of the difference (Φ−Φ₀) between the reference phase-difference Φ₀ and the measured phase-difference Φ, and then outputs the difference determined as an amount of phase variation ΔΦ to CPU 49.

The CPU 49 compares the amount of phase variation ΔΦ1 of the reflected-waves Vd1 from the antenna 3 with the amount of phase variation ΔΦ2 of the reflected-waves Vd2 from the antenna 4, and then switches the switch 44 for selecting an antenna having a smaller amount of phase variation.

(Antenna Selection Processing)

Referring now to FIG. 11, the operation for selecting an antenna in accordance with this embodiment will be explained. In the description hereinafter, though it is assumed that the antenna 4 is used at first as in the case of the first embodiment, it is of course possible to construct this embodiment for using the antenna 3 at first.

First, the amount of phase variation ΔΦ₂ of the antenna 4 is continuously measured by the amount-of-phase-variation measurement circuit 55 (Step S110). The CPU 49 compares a predetermined threshold value ΔΦₜₕ for the phase variations with the value ΔΦ₂ measured at Step S110 (Step 112). If ΔΦ₂ is smaller than ΔΦₜₕ, switching of the antenna is not performed, and then the process is loop-backed to Step 110 and repeats the measurement of ΔΦ₂. On the other hand, if ΔΦ₂ is equal to or larger than ΔΦₜₕ, the CPU 49 controls and switches the selection switch 44 in order that the antenna 3 may be used for transmission (Step S114).

After switching the switch 44, the amounts of phase variations ΔΦ₁ of the antenna 3 is continuously measured by the amount-of-phase-variation measurement circuit 55 (Step S116). The CPU 49 compares a predetermined threshold value ΔΦₜₕ for the amount of phase variation with the value ΔΦ₁ measured at Step S116 (Step 118). If ΔΦ₁ is smaller than ΔΦₜₕ, switching of the antenna is not performed, and then the process is loop-backed to Step 116 and repeats the measurement of ΔΦ₁. On the other hand, if ΔΦ₁ is equal to or larger than ΔΦₜₕ, the CPU 49 controls and switches the selection switch 44 in order that the antenna 4 is used for transmission (Step S120).

Continuously performing the processing described above always allows good transmission.

[A Variation of the Third Embodiment]

As is in the case of the first embodiment, this embodiment also allows that an antenna having a smaller value of ΔΦ₁ and ΔΦ₂ is used by measuring not only the amount of phase variation of the antenna being in use but also the amounts of phase variation of reflected-waves of both antennas. In this case, as in the case of the second embodiment, it is also possible to measure the amounts of phase variation of the antenna 3 and 4 by time-sharing a pilot segment. Furthermore, it is possible to use two amount-of-phase-variation measurement circuits 55 such that each of measurement circuits is disposed the matching circuit and the selection switch 44 for measuring the amount of phase variation. Thus, the CPU 49 can select an appropriate antenna using the results of measurement for use in a data transmission segment.

[Fourth Embodiment]

Next, the fourth embodiment of the present invention will be explained. In the first and third embodiments, the amount of level variation or the amount of phase variation of reflected-waves caused by a variation in impedance of each antenna is used for selection of antennas. Although these embodiments can produce a certain effect, use of both the amount of level variation and the amount of phase variation allows more appropriate selection of antennas. That is, this embodiment corresponds to a combination of the first and third embodiments.

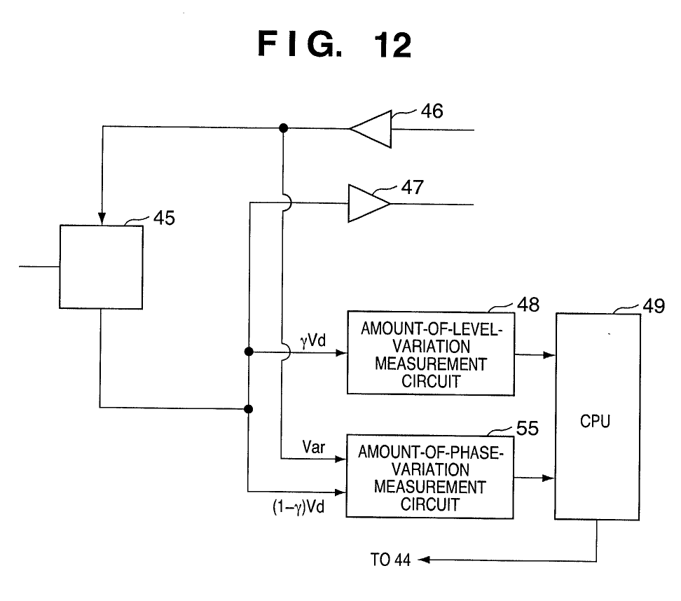

In order to implement this embodiment, it is necessary to measure both the amount of level variation and the amount of phase variation at the same time. For this purpose, as shown in FIG. 12, this embodiment utilizes both an amount-of-level-variation measurement circuit 48, corresponding to the reflected-wave measurement circuit used in the first embodiment, and the amount-of-phase-variation measurement circuit 55 used in the third embodiment. Here, it is noted that the reference name of “an amount-of-level-variation measurement circuit 48” is intended clearly to indicate that its measurement-target is different from that of the amount-of-phase-variation measurement circuit 55. The CPU 49 switches the selection switch 44 to select an appropriate antenna on the basis of the output results from both measurement circuits 48 and 55.

In this embodiment, as shown in FIG. 12, a reflected-wave Vd is input both to the amount-of-level-variation measurement circuit 48 and to the amount-of-phase-variation measurement circuit 55 for detecting both the amount of level variation and the amount of phase variation of the reflected-wave Vd. At this time, it is assumed that the reflected-wave Vd is input to the amount-of-level-variation measurement circuit 48 and to the amount-of-phase-variation measurement circuit 55 in the proportion of γ to 1−γ, respectively. Thereby, for example, the phase difference Φ between the reflected-wave Vd and transmitting signal Var, measured by the amount-of-phase-variation measurement circuit 55, can be expressed by the following equation.

$$Φ = θ d - φ = {cos}^{- 1} [ \frac{2}{( 1 - γ ) {V}_{d} \times {V}_{ar}} \times {V}_{OUT} ] \qquad ( 6 )$$

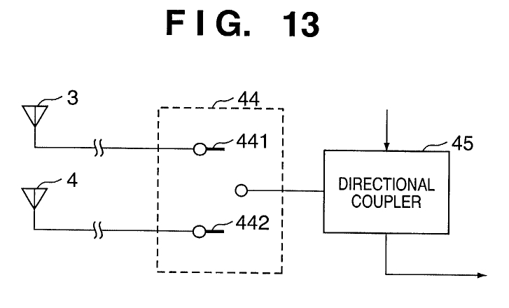

Further, in this embodiment, if use of both the amount of level variation and the amount of phase variation can not determine significant difference existed between the antenna 3 and 4, then both antennas will be used. To this end, the switch 44 is arranged as shown in FIG. 13. That is, the switch 44 comprises two switches 441 and 442. The CPU 49 switches each of the switches 441 and 442 such that either the antenna 3 or 4, or both of them can be selectively connected to the directional coupler 45.

The arrangement of FIG. 13 is only one example. Provided that either or both of the antennas 3 and 4 can be connected to the directional coupler 45, any arrangement can be implemented.

(Antenna Selection Processing)

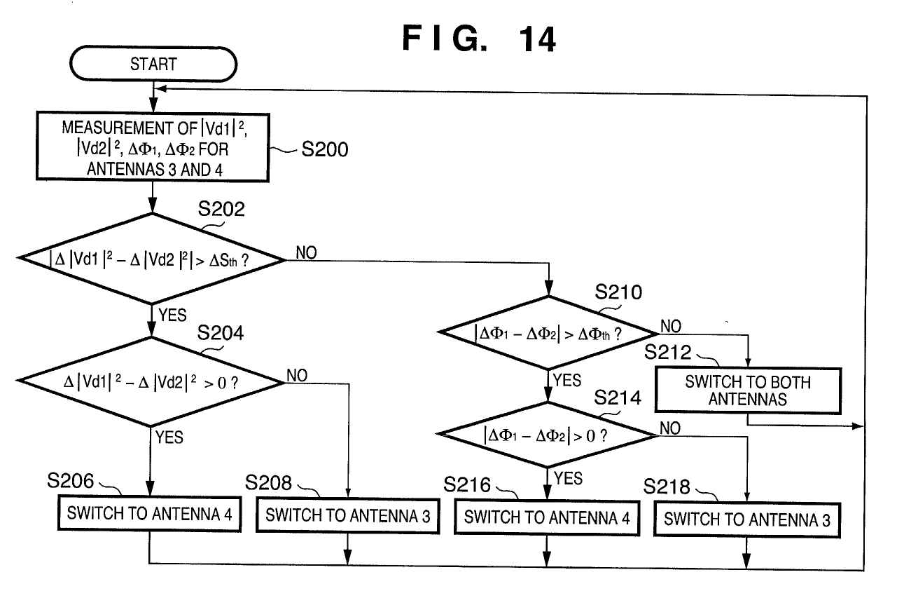

Referring now to the flow chart shown in FIG. 14, the operation of antenna selection in accordance with this embodiment will be explained. The following will explain the case in which the antenna selection will be performed on the basis of the amount of phase variation if a difference between the amounts of the level variation of antennas is smaller than a predetermined value. However, it is of course possible that the antenna selection based on the amount of level variation is performed if a difference between the amounts of phase variation of antennas is smaller than a predetermined value.

First, at Step S200, the amounts of the level variation Δ|Vd1|² and Δ|Vd2|² and the amounts of phase variation ΔΦ₁ and ΔΦ₂ of the reflected-waves Vd1 and Vd2 for the antennas 3 and 4 are respectively determined in the same manner as in the case of Step's S81-S84 of FIG. 8 described in the second embodiment. That is, the antenna 3 is selected by the switch 441 in a pilot segment A and the antenna 4 is selected by the switch 442 in a pilot segment B, and then the amount-of-level-variation measurement circuit 48 and the amount-of-phase-variation measurement circuit 55 perform the respective measurements.

Thereby, Δ|Vd1|² and ΔΦ₁ are determined in the pilot segment A, and Δ|Vd2|² and ΔΦ₂ are determined in the pilot segment B. Then, these values are input to the CPU 49.

Then, at Step S202, it is examined whether or not a difference (|Δ|Vd1|²−Δ|Vd2|²|) between the amounts of the level variation of each antenna is larger than a predetermined threshold value (ΔSth). As a result, if the difference (of the amounts of the level variation) is larger than the threshold, a comparison between Δ|Vd1|² and Δ|Vd2|² is performed at Step S204. Then, an antenna having a smaller amount of level variation is selected (Step S206 and S208).

On the other hand, at Step S202, if the difference between the amounts of the level variation is equal to or smaller than the threshold value, that is, there is no significant difference between the level variations, the process moves to Step 210. At Step 210, it is examined whether or not a difference |ΔΦ₁−ΔΦ₂| between the amounts of phase variation of the respective antennas is larger than a predetermined threshold value (ΔΦₜₕ). As a result, if the difference of the amounts of the level variation is larger than the threshold, a comparison between ΔΦ₁ and ΔΦ₂ is performed at Step S204, and an antenna having a smaller amount of phase variation is selected (Step S216 and S218).

At Step S210, if the difference between the amounts of the phase variation is equal to or smaller than the threshold value, that is, there is no significant difference between the phase variations, the process moves to Step 212, and then select both antennas 3 and 4.

The CPU 49 controls the switch 441 and 442 such that each antenna selected at Step S206, S208, S212, S216, and S218 may be respectively connected to the directional coupler 45. Then, the CPU 49 uses the selected antenna for data transmission in the data segment shown in FIG. 7. The processing described above will be continuously performed.

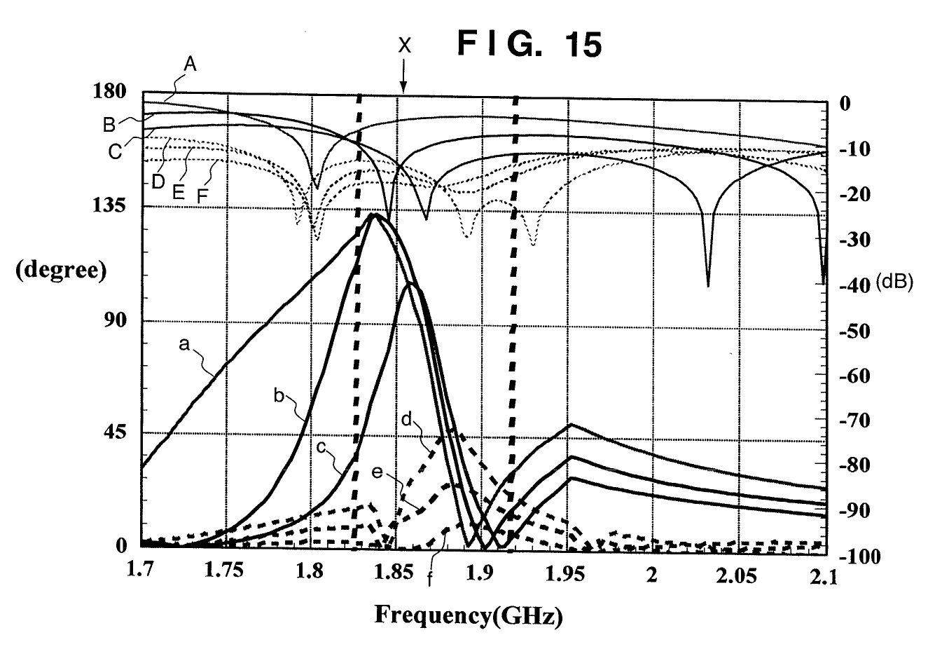

FIG. 15 shows an example of the calculated values of the amounts of level variation and the amounts of phase variation. Therein, these amounts were measured for a terminal shown in FIG. 1B when it was placed near a object. In this figure, the curves A-F described at the top are for the amounts of level variation [dB], and the curves a-f described at the bottom are for the amounts of phase variation [deg]. Further, the solid lines represent the measured values of the antenna nearer to the object, and the dotted lines represent those of the antenna farther from the object. The curves A and a are for the case where the distance from the ground conductor 2 to the object is 10 mm, and the curves B and b are for the distance of 15 mm, and the curves C and c are for the distance of 20 mm, respectively.

As shown in FIG. 15, for example, at the frequency X, the amounts of level variation of the antenna nearer to the object and those of the antenna farther from the object are close to each other or cross each other, and thus there are little difference observed between them. Because of this reason, if the antenna selection is performed only on the basis of the amount of level variation at this frequency, there is the possibility of selecting an antenna nearer to the object in error. In this embodiment, however, since the amount of phase variation is taken into account in addition to the amount of the level variation, such an erroneous selection of antennas can be avoided. In actual fact, at the frequency X, although no significant level variation is observed, significant differences in the phase variation are present between the antenna nearer to the object and the antenna farther from it. As a result, use of the antenna selection including phase variations and level variations as described above can avoid the selection of erroneous antennas.

[Fifth Embodiment]

In all the embodiments described above, an effect of the leakage signal of the transmitting signal from the directional coupler 45 (Sleak in FIG. 5) has been neglected. However, it is desirable for correct selection of antennas that the amount-of-level-variation measurement circuit 48 and the amount-of-phase-variation measurement circuit 55 should measure pure reflected-waves. This embodiment allows more correct detection of the amount of the level variation and the amount of phase variation which do not include the component of the leakage signal Sₗₑₐₖ. Here, although the following describes compensation for an effect of the leakage signal in the case of the fourth embodiment, the method of compensation for the leakage signal in accordance with this embodiment can be applied to the first-third embodiments. Further, for simplifying description, Sₗₑₐₖ is represented only as S₁ in the following explanation.

First, if the S₁ is present, the reflected-wave Vd′ actually input into the amount-of-level-variation measurement circuit 48 and the amount-of-phase-variation measurement circuit 55 is the sum of a true reflected-wave Vd and a leakage signal S₁:

Vd′=Vd+S₁ (7)

On the other hand, the relation between the transmitting signal Var output from the transmitting amplifier 46 and the reflected-wave Vd can be expressed using a coefficient K as follow:

Vd=K·Var (8)

In this case, the amplitude term IKI of the coefficient K corresponds to m times the amplitude |Vd| of the reflected-wave Vd (m is a constant known in advance). Further, the phase term of the coefficient K corresponds to the phase difference between the reflected-wave Vd and the transmitting signal Var and is therefore equal to the phase difference Φ described above.

If using this expression, the reflected-wave Vd′ affected by the leakage signal S₁ can be expressed as follows:

Vd′=K′·Var (9)

Therefore, if the true coefficient K can be determined by correcting the coefficient K′ obtained from the actually measured amplitude |Vd′| of the reflected-wave Vd′ and the phase difference Φ′, then it becomes possible to obtain the amplitude |Vd| and phase difference Φ of the pure reflected-wave Vd, not including the effect of the leakage signal S₁, from the amplitude term and the phase term of the coefficient K.

Generally, in order to correct a reflection coefficient Γ of an antenna, the following equation is used.

Γ_{M}=D+(1+T_{R})Γ_{A} (10)

Therein, FM represents a measured value, D a coupling error, T_{R} a frequency response error, and Γ_{A} a true value. Therefore, if the factors D and T_{R} are known, a true reflection coefficient Γ_{A} can be determined from a measured reflection coefficient Γ_{M}. In order to determine factors D and T_{R}, this embodiment measures, in advance, the reflection coefficient Γ₅₀ when the antenna is replaced with a load of 50 Ω and the reflection coefficient Γ₀ when the antenna is short-circuited. When the antenna is replaced with a load of 50 Ω, reflection will not occur theoretically, so that the true reflection coefficient should be zero. As a result, the term of (1+T_{R}) in the correction equation described above can be neglected, and then the following equation is obtained:

Γ₅₀=D (11)

Further, when the antenna is short-circuited, total reflection occurs with the phase rotation of 180° and also the effect of the leakage signal S₁ can be neglected substantially. As a result, the term of D in the correction equation described above can be neglected, and the following equation is then obtained.

Γ₀=1+T_{R} (12)

Therefore, by using the factors D and T_{R} obtained in these manner and the correction equation described above, it becomes possible to determine a true reflection coefficient Γ_{A} from a actually measured reflection-coefficient Γ_{M}.

Now, the above coefficient K is not the antenna reflection coefficient Γ itself, but is in a predetermined proportionality to the reflection coefficient Γ (for example, n times: n is a constant known in advance). Therefore, by substituting n times the coefficient K′ obtained by measurement into the correction equation as Γ_{M}, it becomes possible to obtain the reflection coefficient K from which the effect of the leakage signal S₁ has been eliminated. Therefore, by proportionally adjusting the amplitude term of this coefficient K according to the constants m and n, it becomes possible to obtain the true amplitude |Vd| of the reflected-wave Vd from which the effect of the leakage signal S₁ has been eliminated. Further, by taking out the phase term of the coefficient K, it becomes possible to obtain the true relative phase difference Φ of the reflected-wave Vd from which the effect of the leakage signal S₁ has been eliminated.

In the amount-of-level-variation measurement circuit 48 and the amount-of-phase-variation measurement circuit 55, by using the measured amplitude (|Vd1′| and |Vd2′|) and measured phase difference (Φ₁′ and Φ₂′) as well as the correction equation in accordance with the above-described correction method, the corrected amplitude (|Vd1| and |Vd2|) and corrected phase-difference (Φ₁ and Φ₂) not including the effect of a leakage signal S₁ are obtained. Then, in the measurement circuit 48 and 55, a true amount of level variation (Δ|Vd1|² and Δ|Vd2|²) and a true amount of phase variation (ΔΦ₁ and ΔΦ₂) of the reflected-wave are determined using the corrected amplitude (|Vd1| and |Vd2|) and the corrected phase difference (Φ₁ and Φ₂), and then the result of measurement (Δ|Vd1|², Δ|Vd2|², ΔΦ₁ and ΔΦ₂) is output to the CPU 49.

In this case, because the coefficient K′ comprising the amplitude and phase difference of the measured reflected-wave is corrected by using the correction equation, the amplitude and phase difference of the reflected-wave are required at the same time. This can achieved as follows: any one of the amount-of-level-variation measurement circuit 48 and the amount-of-phase-variation measurement circuit 55 provides the amplitude or the phase difference to the other and then, in the other measurement circuit concerned, the corrected amplitude and corrected phase difference are determined and then the results are provided to said one measurement circuit. Alternatively, the amplitude and phase difference of the reflected-wave measured by the amount-of-level-variation measurement circuit 48 and the amount-of-phase-variation measurement circuit 55 are passed to the CPU49 once. Thereafter, the CPU 49 determines the corrected amplitude and corrected phase difference and returns them to the amount-of-level-variation measurement circuit 48 and the amount-of-phase-variation measurement circuit 55, respectively. Then, each measurement circuit 48,55 determines the corrected amount of level variation and the corrected amount of phase variation.

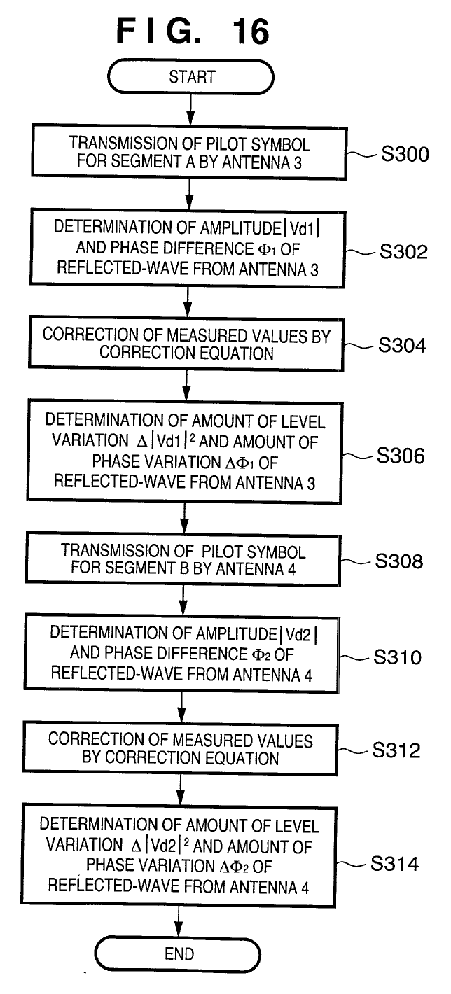

FIG. 16 shows the flow chart in which the correction processing in accordance with the embodiment is applied to the Step S200 shown in FIG. 14. First, at Step S300, the symbol of a pilot segment A are transmitted using the antenna 3. Then, the amplitude |Vd1| of the reflected-wave Vd1 from the antenna 3 and the phase difference Φ₁ between the reflected-wave Vd1 and the transmitting signal Var are determined (Step S302). In this case, as described above, since the reflected-wave input to each measurement circuit 48, 55 includes the effect of the leakage signal S₁, that is the reflected-wave Vd′, the phase difference Φ₁, which includes the effect of the leakage signal S₁, can be obtained from the following equation.

$$Φ i = θ d - φ = {cos}^{- 1} [ \frac{2}{( 1 - γ ) {V}_{d}^{′} \times {V}_{ar}} \times {V}_{OUT} ] \qquad ( 13 )$$

Then, at Step S304, the corrected amplitude |Vd1| and the corrected phase difference Φ₁ of the reflected-wave are determined on the basis of the measured amplitude |Vd1| and the measured phase difference Φ₁ using the correction equation (10) including the factors D and TR obtained in advance. Then, the amount of level variation A|Vd1|² and the amount of phase variation ΔΦ₁, not including the leakage signal S₁, are determined from the corrected amplitude |Vd1| and the corrected phase difference Φ₁ of the reflected-wave (Step S306).

Then, at Step S308-S314, the same processing as in pilot segment A is performed for the antenna 4 by using a pilot segment B. As a result, the amount of level variation Δ|Vd2|² and the amount of phase variation ΔΦ₂, not including the leakage signal S₁, are determined.

Thereafter, by performing the processing following Step S202 in FIG. 14 by using these values, more accurate selection of antennas will be possible.

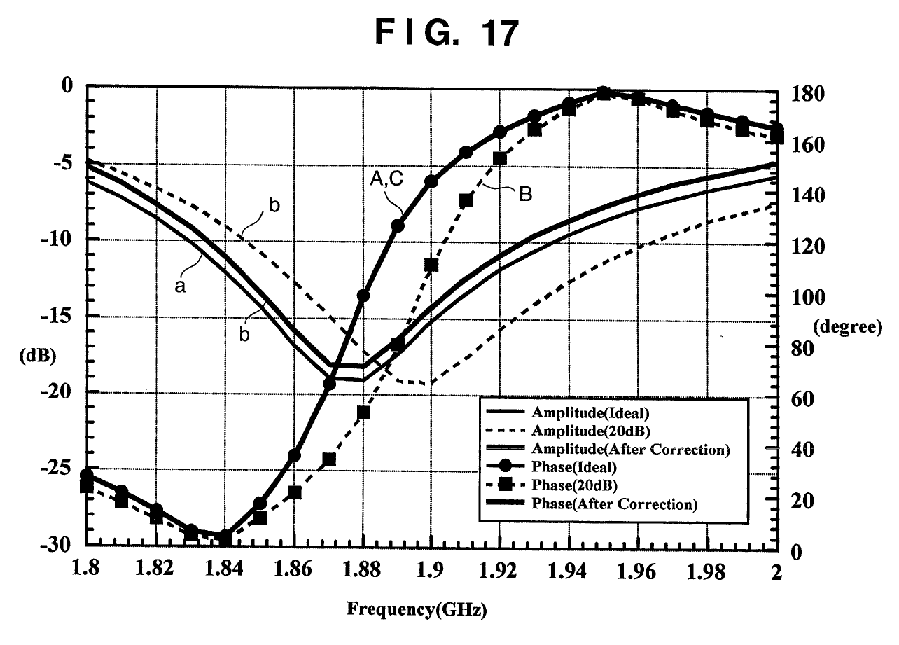

FIG. 17 shows ideal values, calculated values including leakage signals and calculated values corrected by the method in accordance with this embodiment with regard to the signal level (specifically, power of amplitude squared) and phase difference of a reflected-wave. In this figure, the curves A-C are for the signal level of reflected-waves, and the curves a-c are for phase differences. Further, the curves A and a are for the ideal values, the curves B and b are for the calculated values for the case using a directional coupler with isolating characteristics of −20 dB, and the curves C and c are for the calculated values corrected by the method in accordance with this embodiment. As clearly understood from FIG. 17, the calculated values corrected by the method in accordance with this embodiment are approximately equal to the ideal values. Therefore, more accurate selection of antennas can be achieved by this embodiment.

[Other Embodiment]

In the embodiments set forth above, the case described is one in which two antennas capable of transmitting are provided. However, three or more antennas may be used. In such case the first embodiment would be so adapted as to use the plurality of antennas by switching among them in regular order, and the second embodiment would be so adapted as to partition the pilot segment according to the number of antennas.

Further, in the second embodiment, the signal-to-interference ratios sent back by the base station are the signal-to-interference ratios (SIR1 and SIR2) of both segments A and B. However, an arrangement may be adopted in which a comparison of these signal-to-interference ratios is performed on the side of the base station and only the result of comparison is transmitted. In this case, a flag indicating which ratio is larger, the result (value) of calculation in accordance with a predetermined calculation formula (e.g., SIR1−SIR2), etc., can be used as the content of the transmission.

Further, in the second embodiment, the frequency with which the antenna control data is transmitted from the base station to the mobile telephone terminal can be set at will. More specifically, this data may be transmitted on a per-time-slot basis, or the data may be transmitted at a predetermined cycle consisting of a plurality of time slots. Alternatively, the data can be transmitted only in a case where there is a change in the size relationship of the signal-to-interference ratio. Of course, these conditions may be combined.

Further, in the foregoing embodiments, the antennas 3 and 4 are transmit/receive antennas and therefore it is also possible to select an antenna upon taking reception sensitivity (reception signal strength) into consideration. In such case it is possible to set at will what weighting to apply to reception signal strength, amount of variation in reflected-wave level and signal-to-interference ratio at the base station when deciding the antenna eventually selected.

For example, in a case where antenna selection is performed taking into account reception signal strength in the first embodiment, an arrangement may be adopted in which reception signal strength is considered only if there is no significant difference between the amounts of variation Δ|Vd1|², Δ|Vd2|² in reflected-wave level, or an arrangement may be adopted in which reception signal strength is taken into consideration in dependence upon the absolute differences between the amounts of variation Δ|Vd1|², Δ|Vd2|² in reflected-wave level and the threshold value ΔSth.

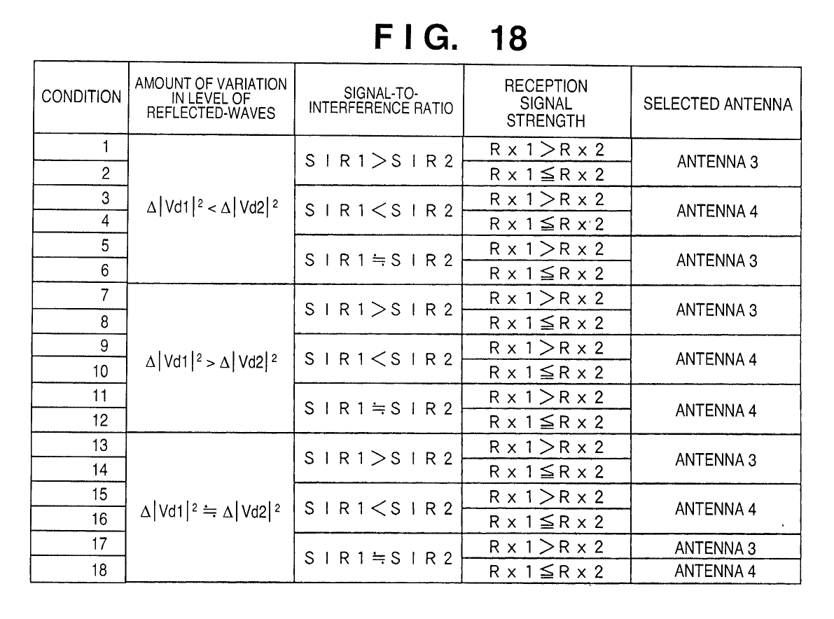

FIG. 18 is a diagram showing an example of a case where reception signal strength has been incorporated in FIG. 9 described in connection with the second embodiment. FIG. 18 illustrates an example in which it is arranged to select in principle an antenna that satisfies the conditions of a small amount of variation in reflected-wave level and a large signal-to-interference ratio measured at the base station, and to select an antenna having a large reception signal strength if there is no significant difference in the amount of variation in reflected-wave level and in the signal-to-interference ratio (conditions 17, 18 in FIG. 10).

Of course, an arrangement may be adopted in which the selected antenna is decided giving priority to reception signal strength over signal-to-interference ratio, and it is possible to so arrange it that an antenna is selected, upon referring to reception signal strength, in dependence upon a difference in the amount of variation in reflected-wave level and/or in the signal-to-interference ratio between antennas.

It should be noted that measurement of reception signal strength may be performed by the reflected-wave measurement circuit 48 or by the baseband signal processing circuit 50.

In accordance with the present invention, as described above, a mobile radio communications apparatus capable of communicating using a radio channel is provided with a plurality of transmitting antennas and it is so arranged that the transmitting antennas are used by dynamically switching among them. This suppresses the influence of the objects in vicinity of antennas and makes stable communication possible.

what is claimed is:

1. A mobile radio communications apparatus having a plurality of transmitting antennas and being capable of communicating via a radio channel comprising:
an antenna selection circuit for dynamically selecting, based on a predetermined condition, an antenna from a plurality of transmitting antennas; and,
a transmitting circuit for providing a transmit signal to the selected antenna.

2. A mobile radio communications apparatus according to claim 1, wherein said antenna selection circuit determines an antenna to be selected based on individual transmission characteristics of said plurality of transmitting antennas.

3. A mobile radio communications apparatus according to claim 2, wherein said antenna selection circuit determines an antenna to be selected based on a variation in impedance of said transmitting antennas.

4. A mobile radio communications apparatus according to claim 2, wherein said antenna selection circuit determines an antenna to be selected based on amount of level variation and/or phase variation of reflected-wave which return from respective ones of said transmitting antennas.

5. A mobile radio communications apparatus according to claim 4, further comprising:
correction circuit for correcting said amount of level variation and/or phase variation, taking an effect of transmit signal leaked from said transmitting circuit, which is included in said reflected-wave, into consideration.

6. A mobile radio communications apparatus according to claim 1, wherein said antenna selection circuit determines an antenna to be selected based upon results of sending a predetermined transmit signal using said plurality of transmitting antennas in succession.

7. A mobile radio communications apparatus according to claim 1, wherein said plurality of transmitting antennas have radiation directivities that differ from one another.

8. A mobile radio communications apparatus according to claim 1, wherein said plurality of transmitting antennas can be used as receiving antennas and said antenna selection circuit determines an antenna to be selected taking into account individual reception-signal strengths of said plurality of transmitting antennas.

9. A mobile radio communications apparatus having at least one receiving antenna and a plurality of transmitting antennas and being capable of communicating via a radio channel comprising:
a transmit circuit for generating a transmit signal supplied to a transmitting antenna;
a receive circuit for processing a receive signal received from said receiving antenna;
switch means for connecting one of said plurality of transmitting antennas to said transmit circuit in accordance with a control signal; and
control means for generating said control signal based upon predetermined conditions.

10. A mobile radio communications apparatus according to claim 9, wherein said control means generates said control signal based upon individual transmission characteristics of said plurality of transmitting antennas.

11. A mobile radio communications apparatus according to claim 9, wherein said control means generates said control signal based upon a variation in individual impedances of said plurality of transmitting antennas.

12. A mobile radio communications apparatus according to claim 9, wherein said control means generates said control signal based upon amount of level variation and/or phase variation of reflected-waves return from respective ones of said transmitting antennas.

13. A mobile radio communications apparatus according to claim 9, wherein said control means measures said amount of level variation and/or phase variation of a reflected-wave return from the transmitting antenna in use and, if this amount of level variation and/or phase variation of a reflected-wave satisfies a prescribed relationship with respect to a predetermined reference value, generates said control signal for controlling said switch means in such a manner that transmission is performed using another transmitting antenna other than said transmitting antenna in use.

14. A mobile radio communications apparatus according to claim 13, wherein said prescribed relationship is a size relationship between said level variation and/or phase variation of a reflected-wave and said predetermined reference value.

15. A mobile radio communications apparatus according to claim 12, wherein said control means comprising:
correcting means for correcting said amount of level variation and/or phase variation, taking an effect of transmit signal leaked from said transmitting circuit, which is included in said reflected-wave, into consideration.

16. A mobile radio communications apparatus according to claim 9, wherein said control means controls said transmit circuit and said switch means so as to transmit a predetermined transmit signal using said plurality of transmitting antennas in succession, measures level variation and/or phase variation of a reflected-wave reflected by each transmitting antenna during transmission performed thereby, and determines a transmitting antenna to be used in subsequent transmission based upon the measurement result.

17. A mobile radio communications apparatus according to claim 9, wherein said receive circuit receives reception-state data, which represents state of reception, sent back from a prescribed receive unit which receives said predetermined transmit signal transmitted using said plurality of transmitting antennas in succession; and said control means determines a transmitting antenna to be used in subsequent transmission based upon said reception-state data.

18. A mobile radio communications apparatus according to claim 9, wherein said plurality of transmitting antennas have radiation directivities that differ from one another.

19. A mobile radio communications apparatus according to claim 9, wherein each of said plurality of transmitting antennas functions as said receiving antenna; said receive circuit measures reception-signal strengths regarding respective ones of said transmitting antennas; and said control means generates said control signal taking into account said reception-signal strengths when necessary.

20. A base station for radio communication with a mobile radio communications apparatus having a plurality of transmitting antennas comprising:
reception-quality measurement means for measuring reception quality in regard to each type of said transmitting antennas used in transmission involving said mobile radio communications apparatus; and
transmit means for sending results of measurement back to said mobile radio communications apparatus.

21. A base station according to claim 20, wherein reception-quality measurement means measures said reception quality with regard to a predetermined signal periodically included in a receive signal from said mobile radio communications apparatus.

22. A base station according to claim 21, wherein measurement of said reception quality is performed for each said predetermined signal transmitted by a respective one of said plurality of transmitting antennas.

23. A method of selecting a transmitting antenna in a mobile radio communications apparatus capable of communicating via a radio channel having at least one receiving antenna, a plurality of transmitting antennas, a receive circuit for processing a receive signal received from said receiving antenna, and switch means for connecting one of said plurality of transmitting antennas to said transmit circuit in accordance with a control signal, characterized by having a control step of generating said control signal based upon predetermined conditions.

24. A method of selecting a transmitting antenna according to claim 23, wherein said control step generates said control signal based upon individual transmission characteristics of said plurality of transmitting antennas.

25. A method of selecting a transmitting antenna according to claim 23, wherein said control step generates said control signal based upon a variation in impedance of said transmitting antennas.

26. A method of selecting a transmitting antenna according to claim 24, wherein said control step generates said control signal based upon amount of level variation and/or phase variation of reflected-waves return from respective ones of said transmitting antennas.

27. A method of selecting a transmitting antenna according to claim 26, wherein said control step includes:
a reflected-wave measurement step of measuring said amount of level variation and/or phase variation of a reflected-wave return from the transmitting antenna in use; and
a decision step of determining whether the measured level variation and/or phase variation satisfies a prescribed relationship with respect to a predetermined reference value;
wherein if said prescribed relationship is satisfied, said control signal is generated for controlling said switch means in such a manner that transmission is performed using another transmitting antenna other than said transmitting antenna in use.

28. A method of selecting a transmitting antenna according to claim 27, wherein said prescribed relationship is a size relationship between said level variation and/or phase variation of a reflected-wave and said predetermined reference value.

29. A method of selecting a transmitting antenna according to claim 26, wherein said control step including:
correcting step for correcting said amount of level variation and/or phase variation, taking an effect of transmit signal leaked from said transmitting circuit, which is included in said reflected-wave, into consideration.

30. A method of selecting a transmitting antenna according to claim 23, wherein said control step controls said transmit circuit and said switch means so as to transmit a predetermined transmit signal using said plurality of transmitting antennas in succession, measures level variation and/or phase variation of a reflected-wave reflected by each transmitting antenna during transmission performed thereby, and determines a transmitting antenna to be used in subsequent transmission based upon the measurement result.

31. A method of selecting a transmitting antenna according to claim 23, wherein said receive circuit receives reception-state data, which represents state of reception, sent back from a prescribed receive unit which receives said predetermined transmit signal transmitted using said plurality of transmitting antennas in succession; and said control step determines a transmitting antenna to be used in subsequent transmission based upon said reception-state data.

32. A method of selecting a transmitting antenna according to claim 23, wherein said plurality of transmitting antennas have radiation directivities that differ from one another.

33. A method of selecting a transmitting antenna according to claim 23, wherein each of said plurality of transmitting antennas functions as said receiving antenna; said receive circuit measures reception-signal strengths regarding respective ones of said transmitting antennas; and said control step generates said control signal taking into account said reception-signal strengths when necessary.
